(19) United States
(12) Patent Application Publication
(10) Pub. No.: US 2008/0073992 A1
(43) Pub. Date: Mar. 27, 2008

(54) CORELESS MOTOR

(75) Inventor: Kenji Kusama, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/856,330

(22) Filed: Sep. 17, 2007

(30) Foreign Application Priority Data
Sep. 15, 2006 (JP) 2006-251347

(51) Int. Cl. H02K 3/04; H02K 3/28; H02K 5/16

(52) U.S. Cl. 310/90; 310/179; 310/208

(57) ABSTRACT

A coreless motor may include: a rotor having a magnet whose circumferential face is magnetized to multiple poles; a stator for rotatably supporting said rotor with a bearing interposed between said stator and said rotor; a coreless coil which is opposed to said circumferential face of said magnet with a space interposed between said coil and said circumferential face and which has a plurality of effective conductors that contribute to torque generation and a plurality of connection conductors that connect the adjacent effective conductors; and a support member having a coil supporting portion that supports said coreless coil; wherein said coil supporting portion supports circumferential faces of said connection conductors to position said coreless coil in the radial direction.

### CROSS REFERENCE

This application claims priority under 35 U.S.C. 119 to Japanese application 2006-251347 filed Sep. 15, 2006, which is incorporated herein by reference.

### TECHNICAL FIELD

At least an embodiment, of the present invention relates to a coreless motor used as a power source in precision machines, and particularly relates to a coreless motor that prevents the degradation of motor properties.

### TECHNICAL BACKGROUND

In the prior art, one of the downsized motors used as a power source in precision machines is a coreless motor (so-called inner rotor motor) in which a coreless coil is arranged at the cylindrical inner circumferential face of a yoke and a permanent magnet magnetized to multiple poles rotates together with the yoke inside the motor. The coreless motor has many advantages over a cored motor (motor with an iron core) in that no cogging torque is produced, less communication spark is produced, resulting in less electric noise, and rotor inertia is low, shortening response time.

The coreless motor disclosed in Japanese Unexamined Patent Publication (Tokkai) No. 2001-136696 (FIG. 1), for example, has a rotor in which a cylindrical holder member is fixed to a shaft and a permanent magnet is arranged on the outer circumference of the holder member, and a stator constructed with an end base, which rotatably retains the rotor with a bearing, and a coreless coil. In order to fix the coreless coil, a coil support is provided for fixing one end of the coreless coil to the end base. More specifically described, the coil support has arc-shaped grooves cut concentric to the center axis at two locations, and a wavy end portion of the coreless coil is fitted and positioned into each of the arc-shaped grooves so that the coil is fixed to the coil support in a self-standing manner. In this way, the coreless coil can maintain a relative positional relationship with the rotor.

In the electric motor disclosed in Japanese Unexamined Patent Publication (Tokkai) No. 2003-111332 (FIG. 1), in order to fix a drive coil composed of an inside coil and an outside coil, these coils are fitted and firmly fixed into the inside diameter portion and the outside diameter portion of a coil boss which is formed of an electric insulation material.

However, in the coreless motors disclosed in the above-mentioned Patent References, it is difficult to obtain a higher level of motor properties and/or performance such as torque performance.

In order to fix the coreless coil in Japanese Unexamined Patent Publication (Tokkai) No. 2001-136696 (FIG. 1), one end of the coil is fixed in the arc-shaped groove as the coil support, provided at two places as described above, in a self-standing manner; therefore, the coil has only low resistance against positional displacement in the radial direction. When the coreless coil is inclined in the radial direction (inwardly or outwardly) because of vibrations caused by the motor rotations or vibrations from the outside, the concentricity between the rotor and the stator is degraded, resulting in an uneven gap between the rotor and the stator. Consequently, motor efficiency and motor properties are degraded. Note that if the inclination of the coreless coil becomes too great, the rotor comes into contact with the stator at the end and as a result, the rotor will be locked.

In order to fix the drive coil in Japanese Unexamined Patent Publication (Tokkai) No. 2003-111332 (FIG. 1), the coil is fitted and firmly fixed into the inside diameter portion and outside diameter portion of the coil boss as described above; the coil boss constitutes a portion of the rotor that rotates (moves) at high speed. Therefore, compared to the motor in which the coreless coil is attached to the stationary end base (so-called stator) (see Japanese Unexamined Patent Publication (Tokkai) No. 2001-136696 (FIG. 1),), there are problems that the coreless coil is deformed by a centrifugal force and that the coil is moved due to an inertia effect of the rotor which occurs during start-up and stop of the motor, resulting in degraded shock resistance.

Thus, at least an embodiment of the present invention may provide a coreless motor in which a coreless coil is prevented from inclining in the radial direction to prevent degradation of motor efficiency and motor properties.

### SUMMARY

Further at least an embodiment of the present invention may comprise

(1) A coreless motor comprising a rotor having a magnet whose circumferential face is magnetized to multiple poles, a stator that rotatably supports the rotor with a bearing interposed between the stator and the rotor, a (tube-like) coreless coil which is opposed to the circumferential face of the magnet with a space interposed between the coil and the circumferential face and which has a plurality of effective conductors that contribute to torque generation and a plurality of connection conductors that connect the adjacent effective conductors, and a support member having a coil supporting portion that supports the coreless coil; wherein the coil supporting portion supports the circumferential faces of the connection conductors to position the coreless coil in the radial direction.

Also, in at least an embodiment, a coreless motor may comprise a rotor having a magnet whose circumferential face is magnetized to multiple poles, a stator that rotatably supports the rotor with a bearing interposed between the stator and the rotor, a (tube-like) coreless coil which is opposed to the magnetic circumferential face with a space interposed between the coil and the circumferential face and which has a plurality of effective conductors that contribute to torque generation and a plurality of connection conductors that connect the adjacent effective conductors, and a support member having a coil supporting portion that supports the coreless coil; wherein the coil supporting portion supports circumferential faces of the connection conductors to position the coreless coil in the radial direction. Therefore, the coreless coil is prevented from inclining in the radial direction and motor efficiency and motor properties are prevented from degradation.

In other words, the coil supporting portion may be formed in the support member to support the circumferential faces of the connection conductors of the cylindrical coreless coil so that the coreless coil is supported by a surface parallel to the rotation axis of the rotor (for example, the perpendicular surface when the coreless motor is placed on the level table). Therefore, compared to a conventional coreless motor, the coreless coil hardly inclines in the radial direction, preventing degradation of the concentricity between the rotor and the coreless coil (stator). This prevents the degradation of motor properties.

The “coreless coil” may be one formed by winding coil in a basket shape or one formed by arranging a predetermined number of (arc-shaped) segment coils.

The “coil supporting portion” is for “supporting” the circumferential face of the connection conductors of the coreless coil; it may support the circumferential faces of the connection conductors using an adhesive; or it may support the circumferential face by interposing some kind of member between the circumferential face of the connection conductors and the coil support.

(2) The coreless motor wherein the support member is constructed with a protrusion that supports the coreless coil to be positioned in the axial direction.

The coreless coil may be supported by the support member while positioned in the radial direction and the axial direction; therefore, the concentricity between the rotor and the coreless coil (stator) can be kept from degradation, which in turn prevents the degradation of motor properties.

(3) The coreless motor wherein at least the coil supporting portion of the support member is formed of an aluminum material.

The circumferential face of the connection conductors of the coreless coil may be supported at the coil supporting portion; therefore, the wider contact area can be obtained, compared to the coil support in Japanese Unexamined Patent Publication (Tokkai) No. 2001-136696 (FIG. 1),). Therefore, heat generated in the coreless coil can be efficiently dissipated to the support member, improving the heat dissipation property. Further, since the support member may have a coil supporting portion formed of an aluminum material, heat conductivity of the support member is increased, further improving the above-mentioned heat dissipation property.

(4) The coreless motor wherein the coreless coil is constructed with a plurality of segment coils in which the effective conductors are overlapped with each other in the circumferential direction.

The coreless coil may be constructed with a plurality of segment coils in which the effective conductors are overlapped with each other in the circumferential direction. Thus, the effective conductors are overlapped with each other and the overlapping portions are fixed by using an adhesive, thus increasing the strength of the cylindrical coreless coil.

(5) The coreless motor wherein the bearing portion is a dynamic pressure bearing portion which is formed of a ceramic material.

The dynamic pressure bearing portion may be composed of a ceramic material; therefore, it obtains higher rigidity, providing a stable dynamic pressure effect, and also the wear amount is reduced, providing higher reliability and longer life expectancy.

(6) The coreless motor wherein the coreless coil is formed to have the circumferential width obtained with a mechanical angle of 90°, and the adjacent coreless coils are positioned such that they are shifted from each other by a mechanical angle of 60° in the circumferential direction.

(7) The coreless motor wherein the coreless coil is a self-fusion wire.

The coreless coil wire uses a self-fusion wire (a wire with adhesive); therefore, the overlapping portions can be self-fused for firm fixing, and in this way, the strength of the coreless coil can be enhanced.

The coreless coil may be prevented from inclining in the radial direction so that motor efficiency and motor properties are kept from degradation. Also, efficiency in manufacturing motors can be improved. Note that the heat dissipation property can be enhanced.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional side view of the mechanical configuration of a coreless motor of an embodiment of the present invention.

FIGS. 2(a) and 2(b) are explanatory illustrations showing how the coreless coils may be mounted.

FIGS. 3(a)-3(d) are process drawings showing how the coreless coils are cylindrically fixed to the support member.

FIGS. 4(a)-4(d) are diagrams showing examples of the connection conductors of the coreless coils.

FIG. 5 is a cross-sectional side view showing the mechanical configuration of a coreless motor in another embodiment.

### DETAILED DESCRIPTION OF THE PREFERRED EMBODIMENTS

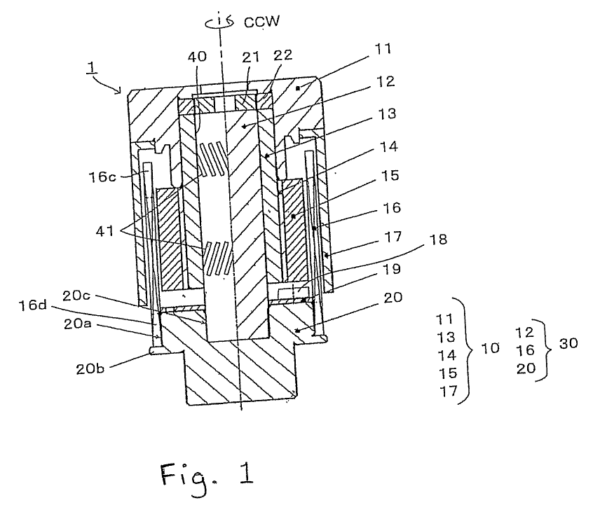

FIG. 1 is a cross-sectional side view of the mechanical configuration of a coreless motor 1 of an embodiment of the present invention. Note that in this embodiment, the coreless motor 1 is of an inner rotor type in which a motor shaft is fixed; as shown in FIG. 1, it is mainly constructed with a rotor 10, a stator 30 and a dynamic pressure bearing portion 40 as a bearing portion.

In FIG. 1, the rotor 10 of the coreless motor 1 comprises a rotor hub 11, a bearing sleeve 13, a yoke 14, a permanent magnet 15 and a back yoke 17. Note that the permanent magnet 15 is magnetized to multiple poles such that N poles and S poles are alternately arranged around the circumferential face thereof. The yoke 14 is placed on the inner circumferential face of the permanent magnet 15.

Also, the back yoke 17 is formed of a magnetic material such as steel, and formed in a cylindrical shape to surround the outer circumferential face of a coreless coil 16 which will be described later.

The stator 30 has a cylindrical coreless coil 16 opposed via a space to the circumferential face of the permanent magnet 15, which is one of the constituents of the rotor 10, a motor shaft 12 and a support member 20 that supports one end of the motor shaft 12.

Further, the support member 20 has a function to dissipate heat generated in the coreless coil 16, etc. In this embodiment, it is composed of an aluminum material which is excellent in heat conductivity.

As shown in FIG. 1, a bearing support portion 20c formed as a recess portion is provided in the center portion of the support member 20. Into the bearing support portion 20c (recess portion), one end of the motor shaft 12 is fitted and fixed, and the bearing sleeve 13 is arranged next to the motor shaft 12 via a small space.

The rotor hub 11 is fixed outside the bearing sleeve 13 in the radial direction (the top side in FIG. 1), and the permanent magnet 15 is attached via the yoke 14 to the bottom side of the sleeve in the FIG. 1.

The back yoke 17 is attached to the rotor hub 11, surrounding the circumferential face of the permanent magnet 15 via a space.

The coreless coil 16 is attached to the support member 20 such that it is positioned in the space between the permanent magnet 15 and the back yoke 17. A Hall device 18 for detecting magnetic poles of the permanent magnet 15 is mounted on a sensor substrate 19 firmly fixed on the support member 20, and thus the device 18 is positioned in the vicinity of the permanent magnet 15. Note that in this embodiment, there are four poles of the permanent magnet 15 (the outer circumferential face is magnetized to NSNS), and a three-phase inner rotor motor is used which has a total of six coreless coils.

The sensor substrate 19, on which the Hall device 18 for detecting magnetic poles is mounted, is attached to the support member 20. On the sensor substrate 19 is provided a pattern that wires six coreless coils 16, and the coil wire is soldered. Note that the coil wire may be pulled out by a lead wire.

The dynamic pressure bearing surface formed on the motor shaft 12 (shaft member) and the dynamic pressure bearing surface formed on the bearing sleeve 13 (as bearing member) are opposed to each other having a predetermined small space in the radial direction between the shaft and the bearing sleeve and also air (bearing fluid) is interposed in the small space (between the dynamic pressure bearing surfaces) so that the dynamic pressure bearing portion 40 as a bearing portion relatively and rotatably supports the shaft member and the bearing member with dynamic pressure obtained by pressuring the bearing fluid with a dynamic pressure generating groove 41 (dynamic pressure bearing generating means) which is cut at least on one of the dynamic pressure bearing surfaces. Note that in this embodiment, the coreless motor 1 shown in FIG. 1 rotates in the CCW direction.

Further, in this embodiment, the motor shaft 12 and the bearing sleeve 13 are formed of a ceramic material.

Thus, the dynamic pressure bearing portion 40 is configured with the motor shaft 12 and the bearing sleeve 13, both of which are manufactured of a ceramic material, and obtains a bearing function with air dynamic pressure; the small space between the motor shaft 12 and the bearing sleeve 13 is several μm.

In this embodiment, the dynamic pressure bearing portion 40 is composed of a ceramic material; therefore, higher rigidity of the material provides a more stable dynamic pressure effect, reducing the amount of wear and providing higher reliability and longer life expectancy.

Although the dynamic pressure bearing portion 40 uses air (as bearing fluid) in this embodiment, it is not limited to air, but a plain bearing other than one using air may be used. Moreover, a bearing member other than the dynamic pressure bearing, such as a rolling bearing like a ball bearing, may be used.

In this embodiment, a first annular attraction magnet 21 is firmly fixed on the top end (FIG. 1) of the motor shaft 12, and a second annular attraction magnet 22 is firmly fixed on the inner circumferential face of the rotor hub 11, opposing the first attraction magnet 21 in the circumferential direction.

The first and second attraction magnets 21 and 22 are magnetized such that their poles are arranged opposite from each other in the axial direction. In this way, the magnets magnetically attract each other and function to position the rotor 10 in the axial direction with respect to the stator 30.

A method of assembling the coreless motor 1 is described next. First, the motor shaft 12 is firmly fixed to the support member 20 and the sensor substrate 19, on which the magnetic pole detection Hall device 18 is mounted, is attached to the face of the support member 20 on the motor shaft 12 side. Next, the six coreless coils 16 are fixed to the support member 20 to be cylindrical. Note that since a feature of the coreless motor 1 is how the coreless coils 16 are mounted onto the support member 20, this process will be described later. After the coreless coils 16 are fixed and the stator assembly is completed, the rotor 10 is attached to the stator. In this manner, the assembly of the coreless motor 1 is completed.

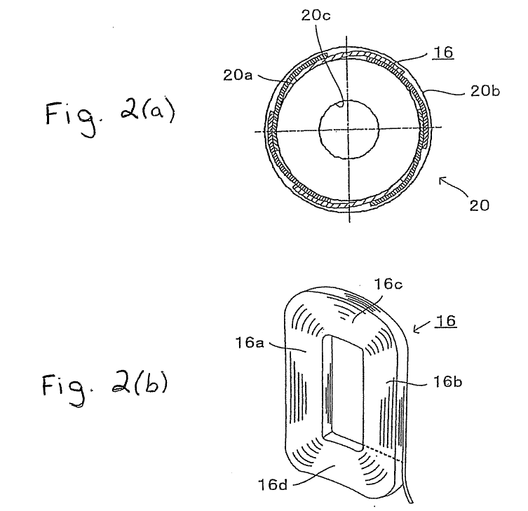

Next is described a method of mounting the coreless coils 16. FIGS. 2(a) and 2(b) are explanatory illustrations to explain how the coreless coils 16 are mounted. Particularly, FIG. 2 (a) is a cross-sectional plan view of the coreless coils 16, focusing only on the coreless coils 16 and the support member 20 in the coreless motor 1 of FIG. 1. FIG. 2 (b) is an appearance configuration of the coreless coils (segment coils) 16.

In FIG. 2 (a), six of the curve-molded coreless coils 16 (see FIG. 2 (b)) are cylindrically fixed to the supporting member 20.

Each coreless coil 16 has a plurality of effective conductors 16a and 16b which contribute to torque generation and a plurality of connection conductors 16c and 16d that connect the effective conductors 16a and 16b.

Further, each coreless coil 16 is formed such that it has the circumferential width obtained with a mechanical angle of 90°, and the adjacent coreless coils 16 are positioned shifted from each other by a mechanical angle of about 60° in the circumferential direction. In other words, as shown in FIG. 2 (a), the effective conductor 16b of one coreless coil overlaps with the effective conductor 16a of the adjacent coreless coil in the circumferential direction.

Thus, the effective conductor 16b of the coreless coil 16 is overlapped with the effective conductor 16a of the adjacent coreless coil 16 and the overlapping portion is fixed by using an adhesive so that the strength of the cylindrically-arranged coreless coils can be enhanced. Note that in this embodiment, a self-fusion wire (a wire with adhesive) is used for the (segment) coil wire; therefore, the overlapping portion is also self-fused for firm fixing. In this way, the strength of the coreless coils can be enhanced.

Focusing on the coreless coil (the segment coil) 16, a portion of the coil is arranged on the inner side in the radial direction of the motor shaft 12 with respect to the adjacent coreless coil 16 on the right side in the circumferential direction (in FIG. 2 (a), the coreless coil 16 adjacently arranged in the counterclockwise direction), and another portion of the coil is arranged on the outer side in the radial direction of the motor shaft 12 with respect to the adjacent coreless coil 16 on the left side in the circumferential direction (in FIG. 2 (a), the coreless coil 16 adjacently arranged in the clockwise direction).

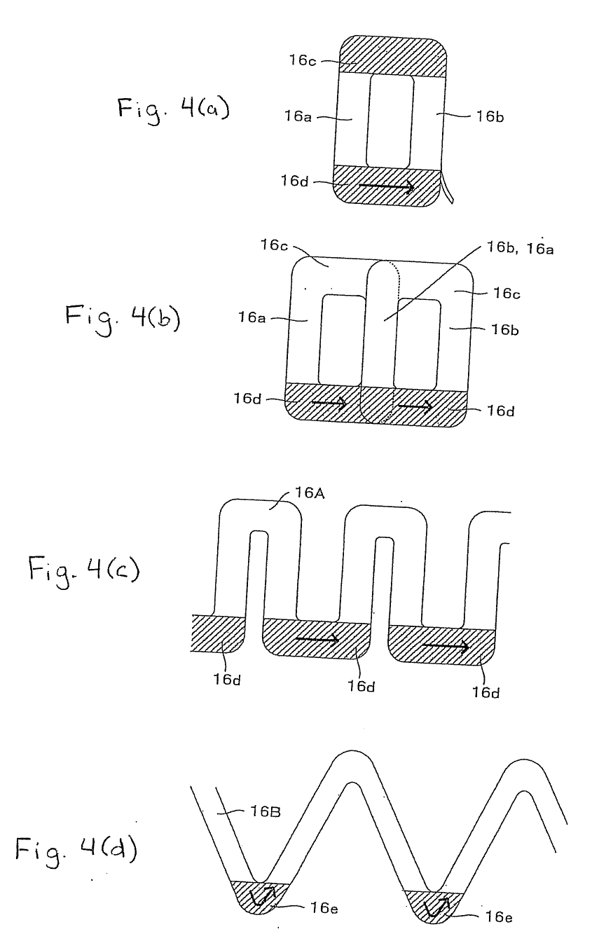

The adjacent coreless coils 16 are arranged such that the effective conductor 16b of one of the coils 16 is overlapped with the effective conductor 16a of the other coil 16 over the entire width (see FIG. 4 (b)). Note that it does not limit how much overlapped.

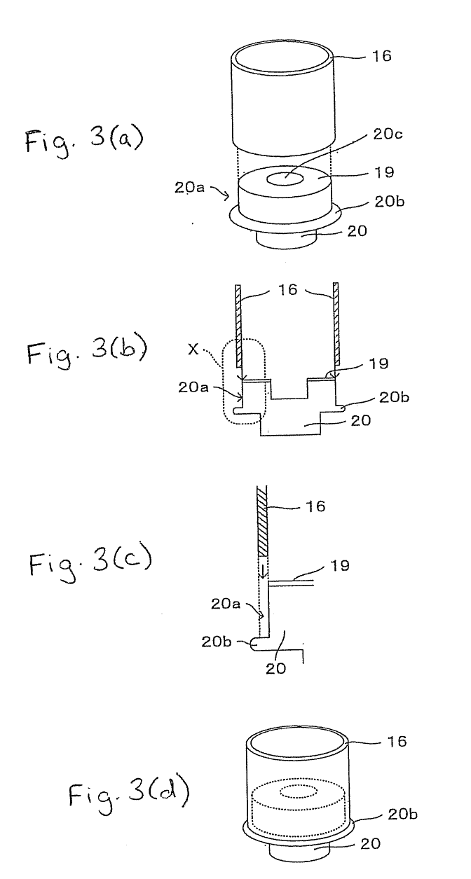

FIGS. 3(a)-3(d) are process drawings (schematic drawings) showing that the coreless coils 16 are arranged in a cylindrical shape and fixed to the support member 20. FIG. 3 (a) is a perspective view of the coreless coils 16 and the support member 20, looking at them diagonally; FIG. 3 (b) is a vertical cross-sectional view of the coils and the support member 20, vertically cutting FIG. 3 (a); FIG. 3 (c) is a magnified drawing of the X portion of FIG. 3 (b); FIG. 3 (d) is a perspective view of the coreless coils 16 fitted to the support member 20.

In this embodiment, as shown in FIGS. 3(a)-3(d), the support member 20 is constructed with not only the above-mentioned bearing support portion 20c, but also a coil supporting portion 20a and a protrusion 20b. The outside diameter of the coil supporting portion 20a is the same as or slightly smaller than the inside diameter of the cylindrically-arranged coreless coils 16 (see FIG. 3 (c)), and the inner circumferential face of the connection conductors 16d of the coreless coils 16 is firmly fixed to the outer circumferential face of the coil supporting portion 20a by using an adhesive.

The protrusion 20b is projected such that the thickness of a coreless coil (a segment coil) 16 can be within the projection height thereof when the inner circumferential face of the connection conductor 16d is fitted (or firmly fixed) to (the outer circumferential face) of the coil supporting portion 20a (see FIG. 3 (c)). In other words, the coreless coils 16 are engaged with the protrusion 20b and the bottom ends of the coreless coils 16 are supported while making contact with the protrusion 20b. In this manner, the coreless coils 16 are completely fixed to the support member 20 (see FIG. 3 (d)).

Note that another member (such as an insulation member) may be interposed between the coil supporting portion 20a and the connection conductors 16e of the coreless coils 16, or another member (such as an insulation member) may be interposed between the protrusion 20b and the bottom ends of the coreless coils 16.

In this embodiment, when the support member 20 is processed, the recess-like bearing support portion 20c and the coil supporting portion 20a can be processed by one chuck; therefore, the concentricity between the inner circumferential face of the bearing support portion 20c and the outer circumferential face of the coil supporting portion 20a can be precisely obtained. Therefore, the gap between the permanent magnet 15 and the back yoke 17, which are the constituents of the rotor 10, and the coreless coils 16 which are the constituents of the stator 30, can be smaller than that in a conventional motor. Consequently, a motor can be downsized even more, and invalid magnetic flux (leakage magnetic flux) from the permanent magnet 15 is reduced, resulting in increased motor efficiency. Note that the coil supporting portion 20a and the protrusion 20b of the support member 20 are insulated accordingly because they make contact with the coreless coils 16.

When the coreless coils 16 are positioned and fixed to the support member 20, the coil supporting portion 20a of the support member 20 supports the connection conductors 16d, the portion of the circumferential face of the coreless coils 16 that barely affects motor properties. FIGS. 4(a)-4(c) shows the connection conductor 16d, which is an example of the portion of the coreless coil 16 that barely affects motor properties.

In a coreless coil (a segment coil) 16 shown in FIG. 4 (a), the above-mentioned connection conductors 16c and 16d are the perpendicular portions in which current flows in the direction perpendicular to the motor shaft 12 of the rotor 10 (see the oblique lined portion in the figure). Of these connection conductors 16c and 16d (the perpendicular portions), the connection conductor 16d is closer to the support member 20; since the direction of current flowing in the connection conductor 16d (see the arrow in the figure) is about perpendicular to the motor shaft 12, the connection conductor 16d barely affects motor properties. Therefore, when the (inner) circumferential face of the connection conductor 16d is supported by the coil supporting portion 20a, the degradation of motor properties, which may be caused by the supporting, can be prevented. FIG. 4 (b) shows the position of the connection conductors 16d of the two coreless coils 16, which barely affects motor properties, when the two coreless coils (segment coils) 16 are overlapped (see oblique lined portion in the figure).

As shown in FIG. 1, the connection conductor 16d is attached to the outer circumferential face of the coil supporting portion 20a such that the entire width thereof is within the projection height of the protrusion of the coil supporting portion 20a; thus, the portion that does not affect motor properties is supported, and therefore, without degrading motor properties, the entire length of the motor can be shortened.

### Effects of the Embodiment

According to the coreless motor 1 shown in FIG. 1, the inner circumferential face of the connection conductor 16d is fitted (or firmly fixed) to the outer circumferential face of the coil supporting portion 20 a; therefore, because the coreless coils 16 are kept from inclining in the radial direction, the entire length of the coreless motor 1 can be shortened, and motor efficiency and motor properties are kept from degradation. Also, efficiency in manufacturing the coreless motor 1 can be improved. Further, the heat dissipation property can be improved.

Also, since the “circumferential face” of the connection conductors 16d of the coreless coils 16 is supported, there is a wider contact area between the coreless coils 16 and the coil supporting portion 20a (the coil support in Japanese Unexamined Patent Publication (Tokkai) No. 2001-136696 (FIG. 1), than that of Japanese Unexamined Patent Publication (Tokkai) No. 2001-136696 (FIG. 1), in which “one end” of the coreless coil is supported. With this, heat generated in the coreless coils 16 can be efficiently dissipated to the support member 20, improving the heat dissipation property. In particular, when the coreless motor 1 is used as a drive source for a product (such as a fan motor) that requires a higher level of torque, heat is increasingly generated and therefore, the heat dissipation property is important; the coreless motor of the present invention is useful in such applications.

Further, the coil supporting portion 20a that supports the circumferential face of the connection conductors 16d of the coreless coils 16 is positioned not on the movable rotor 10, but on the stator 30. Therefore, heat generated in the coreless coils 16 can be easily dissipated via the stationary support member 20. From this view point, the heat dissipation effect is high compared to the one in Japanese Unexamined Patent Publication (Tokkai) No. 2003-111332 (FIG. 1) in which heat is dissipated only via a rotor which is a movable member.

Since the support member 20 is composed of an aluminum member that is excellent in heat conductivity, the heat dissipation property can be improved even more. Note that the heat dissipation property can be improved as long as at least the coil supporting portion 20a of the support member 20 is composed of an aluminum member.

In the coreless motor 1, the rotor 10 is concentrically and rotatably supported by the stator 30 via the dynamic pressure bearing portion 40; therefore, it can be positioned and fixed such that the cylindrical face of the coreless coils 16 arranged on the support member 20 (the coil supporting portion 20a), which is a constituent of the stator 30, and the opposing face between the permanent magnet 15 and the back yoke 17, which are constituents of the rotor 10, can be distanced evenly. Therefore, the coil supporting portion 20a is concentric to the coreless coils 16, and a more precise positioning is possible.

In the present invention, the coreless coils are supported by the coil supporting portion formed to the support member that rotatably supports the rotor. Therefore, unlike the conventional electric motor disclosed in Japanese Unexamined Patent Publication (Tokkai) No. 2003-111332 (FIG. 1) the coreless coils will not be deformed by a centrifugal force, and the fixing strength and shock resistance of the coreless coils 16 can be improved.

According to the coreless motor 1 of this embodiment, the connection conductors 16e of the coreless coils 16 are supported by the coil supporting portion 20a and the protrusion 20b; therefore, the connection conductors 16e of the coreless coils 16 are supported not only on the inner circumferential face thereof but also on the bottom end thereof. As a result, the coreless coils 16 are kept from inclining in the radial direction, and therefore are held with more stability compared to the conventional motor.

By preventing the coreless coils 16 from inclining in the radial direction, the concentricity between the permanent magnet 15 and the back yoke 17 (rotor 10) and the coreless coils 16 (stator 30) can be improved, which in turn prevents the degradation of motor properties. When the concentricity is improved, an extra gap is unnecessary and the gap between the rotor 10 and the stator 30 can be smaller compared to the conventional one. Consequently, the coreless motor 1 can be downsized even more, and by downsizing the coreless coils and the permanent magnet, magnetic resistance can be reduced to increase motor efficiency.

Also, because the coreless coils 16 are supported by the support member 20, a jig is not necessary to support the coreless coils 16, thus simplifying the component-fixing process when manufacturing the motor and improving manufacturing efficiency.

### Modification Example

In the above-mentioned embodiment, a predetermined number of segment coils are arranged to form the coreless coils 16; however, the same effect can be obtained when using the coreless coils 16A in which a coil is wound in a basket shape as shown in FIG. 4 (c). In other words, the coil supporting portion 20a supports the circumferential face of the connection conductors 16d of the coreless coils 16A, that is the portion of the coreless coils 16A which does not affect motor properties; therefore, motor properties are kept from degradation and the concentricity between the rotor 10 and the coreless coils 16A is kept from degrading.

It is possible to use the coreless coils 16B shown in FIG. 4 (d), in which a coil is wound like a basket and whose development drawing is a triangular wavy shape. Thus, even when current does not flow in the direction perpendicular to the motor shaft 12 of the rotor 10 (see the arrows in the figure), the present invention can be used as long as the coil supporting portion 20a is formed to support the circumferential face of the connection conductors 16e of the coreless coils 16B, that is the portion of the coils 16B that barely affects motor properties.

For example, a coil can be wound in such a way that, when the basket-type coreless coils 16B are developed, the development drawing thereof is in a rectangular, lozenge, or hexagonal shape. Also, when the coreless coils are formed by arranging a plurality of segment coils, each segment coil is in a square frame shape.

Although a three-phase inter rotor motor having the structure of 4 poles and 6 segment coils is used in this embodiment, the present invention is not limited to this, but it may be a two-phase motor, an outer rotor motor, or a motor having the structure of 8 poles and 12 segment coils. Also, six coreless coils 16 are fixed in this embodiment; however, the number and shape of the coreless coils 16 are not limited to the above.

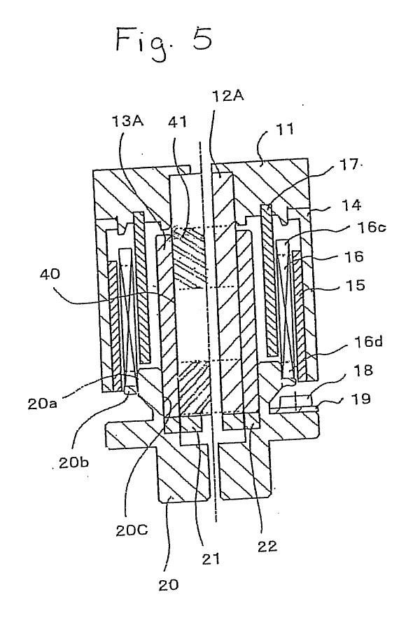

In this embodiment has been described the configuration of a fixed-shaft type coreless motor in which the motor shaft 12 is fixed to the support member 20; however, as shown in FIG. 5, a structure may be used in which the bearing sleeve 13A is fixed to the support member 20 and the rotor 10 is rotatably supported. In other words, the structure may be that the motor shaft 12A is fixed to the rotor hub 11, the coreless coils 16 and the bearing sleeve 13A are fixed to the support member 20, and the permanent magnet 15 fixed to the rotor hub 11 rotates in a space between the coreless coils 16 and the bearing sleeve 13.

### POSSIBLE INDUSTRIAL USE

The coreless motor of the present invention can prevent the coreless coils from inclining in the radial direction, and motor efficiency and motor properties are kept from degradation.

What is claimed is:

1. A coreless motor comprising:
a rotor having a magnet whose circumferential face is magnetized to multiple poles;
a stator for rotatably supporting said rotor with a bearing interposed between said stator and said rotor;
a coreless coil which is opposed to said circumferential face of said magnet with a space interposed between said coil and said circumferential face and which has a plurality of effective conductors that contribute to torque generation and a plurality of connection conductors that connect the adjacent effective conductors; and
a support member having a coil supporting portion that supports said coreless coil;
wherein said coil supporting portion supports circumferential faces of said connection conductors to position said coreless coil in the radial direction.

2. The coreless motor as set forth in claim 1 wherein said support member is constructed with a protrusion that supports said coreless coil to be positioned in the axial direction.

3. The coreless motor as set forth in claim 1 wherein at least said coil supporting portion of said support member is formed of an aluminum material.

4. The coreless motor as set forth in claim 1 wherein said coreless coil is composed of a plurality of segment coils in which said effective conductors are overlapped with each other in the circumferential direction.

5. The coreless motor as set forth in claim 1 wherein said bearing portion is a dynamic pressure bearing portion which is formed of a ceramic material.

6. The coreless motor as set forth in claim 4 wherein said coreless coil is formed to have the circumferential width obtained with a mechanical angle of 90°, and said adjacent coreless coils are shifted from each other by a mechanical angle of 60° in the circumferential direction.

7. The coreless motor as set forth in claim 1 wherein said coreless coil is a self-fusion wire.
